(19) United States
(12) Patent Application Publication
(10) Pub. No.: US 2004/0000540 A1
(43) Pub. Date: Jan. 1, 2004

(54) Laser texturing of surfaces for biomedical implants

(76) Inventors: Winston O. Soboyejo, Skillman, NJ (US); Mingwei Li, Sunnyvale, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/445,266

(22) Filed: May 23, 2003

Related U.S. Application Data
(60) Provisional application No. 60/382,986, filed on May 23, 2002.

(51) Int. Cl. B23K 26/00

(52) U.S. Cl. 219/121.69

(57) ABSTRACT

A method for modifying and patterning biomedical implant materials that are interfaced to tissue is provided. A pulsed solid state laser is provided that produces a UV output. The UV output is directed to the surface. Micro-grooved surfaces are produced with groove depths in the range of 1 100 μm.

### CROSS-REFERENCE TO RELATED APPLICATIONS

This application claims the benefit of U.S. Provisional Application Serial No. ______, filed May 23, 2002, entitled UV Laser Processing and Microgroove Geometry for Cell/Surface Integration in Biomedical Implants, and further identified as attorney docket number 7616-99-49.

### FIELD OF THE INVENTION

The present invention relates generally to methods and systems for laser surface texturing and more specifically to the use of pulsed solid state lasers for surface modification and patterning of biomedical implant materials that are interfaced to tissue.

### BACKGROUND OF THE INVENTION

A number of applications that require a roughened or textured surface on a substrate. A variety of methods have been utilized to produce the texturing including etching, blast texturing, stamping, abrading, laser treatment, and the like. See for example U.S. Pat. No. 6,350,506. Laser radiation has been found to be effective in producing conically shaped grooves on substrates as well as on metal or alloy coating.

Biomedical implants also can require structured surface. U.S. Pat. No. 6,261,322 discloses structured surfaces in relation to the deposition of biocompatible composite coatings which can promote tissue in-growth for a medical implant. Texturing of a bone surface to prepare a proper scaffolding for bone graft has also been described in U.S. Pat. No. 5,112,354.

U.S. Pat. No. 5,322,988 discloses the use of laser irradiation to impart a texture at a surface immersed in an ambient gas in an effort to improve a silicon-based device performance such as a CCD. In this method, a UV laser, such as an excimer, is used to promote a chemical reaction between an ambient and a surface thereby imparting texture to the surface.

Ti-6Al-4V alloys have been used in hip and dental implants due to their balance of biocompatibility, corrosion resistance, wear resistance and fatigue resistance. The average life span of most hip replacements is between 10-12 years. This relatively short life span is attributed largely to osteolysis, which is induced by polyethylene particles from the cup sections of total hip replacements. Progressive detachment of the hip replacement is also exacerbated by cyclic damage processes that occur during normal hip function. This has stimulated various efforts to improve the adhesion between bone and biomedical implants.

Most of the current efforts to improve the adhesion between bone and Ti-6Al-4V have relied on the use of surface roughening. This is often done by blast texturing selected regions of the Ti-6Al-4V implant with Al₂O₃ or SiC particles in order to roughen the surface and facilitate bone-implant integration. Unfortunately, these methods can give rise to the development of random bone cell orientations that may lead to scar tissue formation. Furthermore, blasting techniques lead to particles that can become embedded in Ti or Ti-6Al-4V and induce diffusion which gives rise to significant alteration in the surface/near-surface chemistry. This may result in the enhancement of local levels of toxic elements such as Al or V. Such increased concentrations of cyto-toxic elements that are present at/near the implant surface after surface treatment are highly undesirable.

Micro-grooved geometries have been used to align cells in order to promote contact guidance on biomedical surfaces. This reduces the extent of scar tissue formation and promotes osseo-integration. Although the earlier micro-groove geometries were introduced with micro-fabrication techniques, more recent micro-groove geometries have been produced using laser-processing techniques. The advantage of the laser is that they can be used in a non-contact mode and employ low input heat. In particular, attempts have been made to produce laser micro-groove geometries, as illustrated in FIGS. 1(a) and 1(b). (FIGS. 2a and 2b) using excimer ultra-violet (UV) lasers and large area masking techniques. However, these attempts have resulted in the creation of extensive micro-cracks. Considerable heat affected zone formation was observed in the microstructure of the grooves, presumably due to high energy produced by the excimer laser used. This can degrade subsequent fatigue performance.

There is a need for improved methods and systems to texture Ti or Ti-6Al-4V surfaces.

### SUMMARY OF THE INVENTION

Accordingly, an object of the present invention is to provide improved methods and systems for surface texturing of materials while minimizing or eliminating micro-cracks.

Another object of the present invention is to provide pulsed solid state lasers, and their methods of use, for surface modification and patterning of biomedical implant materials that are interfaced to tissue.

It is a further object of the invention to provide a method using a pulsed laser to create a micro-grove pattern and align it to tissue cells by contact guidance.

It is still another object of the present invention to provide a method employing pulsed UV laser system adapted to a laser texturing procedure that will not result in any alterations of the chemical or physical properties of an implant material.

### BRIEF DESCRIPTION OF THE DRAWINGS

FIG. 1: Shows a schematic of a pulsed laser system for surface texturing.

FIG. 2. Applications of Ti-6Al-4V in biomedical implants: (a) Total hip replacement and (b) Dental implant (adapted from Ref. 2)

FIG. 3: Schematic of a total hip replacement (taken from reference 25). Illustrates the secretion of particles that are harmful to the body and the implant.

FIG. 4: Scanning electron microscopy photographs of excimer laser ablated grooves: (a) Longitudinal grooves and (b) Circumferential grooves (adapted from Ref. 16)

FIG. 5: Shows results of alignment/contact guidance of cells in a textured surface. MC3T3-E1 rat osteoblasts on: (a) rough alumina blasted Ti-6Al-4V surface and (b) 12 μm laser micro-grooved Ti-6Al-4V.

FIG. 6. Scanning electron microscopy photographs of the micro-grooved Ti-6Al-4V geometries of Sample C1. (a,b) Surface topology and groove widths at 300× and 600× (c,d) Groove depths at 600× and 800×.

FIG. 7. Scanning electron microscopy photographs of the micro-grooved Ti-6Al-4V geometries of Sample C2. (a,b) Surface topology and groove widths at 300× and 600× (c,d) Groove depths at 600× and 800×.

FIG. 8. Scanning electron microscopy photographs of etched cross-sections of Samples C1 and C2. (a, b) Sample C1 at 600× and 2000× (c,d) Sample C2 at 600× and 2000×.

FIG. 9: Scanning electron microscopy photographs of cells growing on Sample C1 after 2-day culture on (a,b) intersection of grooved and polished regions at 100× and 200×, (c,d) polished region at 100× and 200×, and (e,f) grooved region at 100× and 200×.

FIG. 10. Scanning electron microscopy photographs of cells growing on Sample C2 after 2-day culture on (a,b) intersection of grooved and polished regions at 100× and 200×, (c,d) polished region at 100× and 200×, and (e,f) grooved region at 100× and 200×.

FIG. 11: Scanning electron microscopy images of the micro-grooved Ti-6Al-4V geometries of groove section #2 in the second parametric study: (a) groove depths at 600× (b) surface topology and groove widths at 600×.

FIG. 12: Schematic of groove geometry.

FIG. 13: Groove wall deformations on laser micro-grooved surface.

FIG. 14: Striations and resolidification packets on laser micro-grooved surface.

FIG. 15: Scanning electron micrographs of Ti-6Al-4V specimens—heat affected zone, fused layer, and solidification cracking in 8 μm circumferentially grooved Ti-6Al-4V specimen (taken from reference 23).

FIG. 16: Scanning electron microscopy photographs of etched cross-sections of grove section #1 in secondary parametric study: (a) 2000× and (b) 600×.

### DESCRIPTION OF THE PREFERRED EMBODIMENTS

In various embodiments, the present invention provides methods and apparatus described herein are particularly well suited to applications requiring surface roughening with a well defined texture or pattern and with minimal side-effects including but not limited to micro cracking, collateral thermal effects, denaturing, and the like. Key advantages of the processes disclosed include the added flexibility provided by the high repetition rate laser used to produce specific pattern geometries on the surface.

Applications that can benefit from the present invention range from the art of biomedical implant preparation and bone grafting to industrial micromachining, marking, decorative texturing and magnetic disc etching.

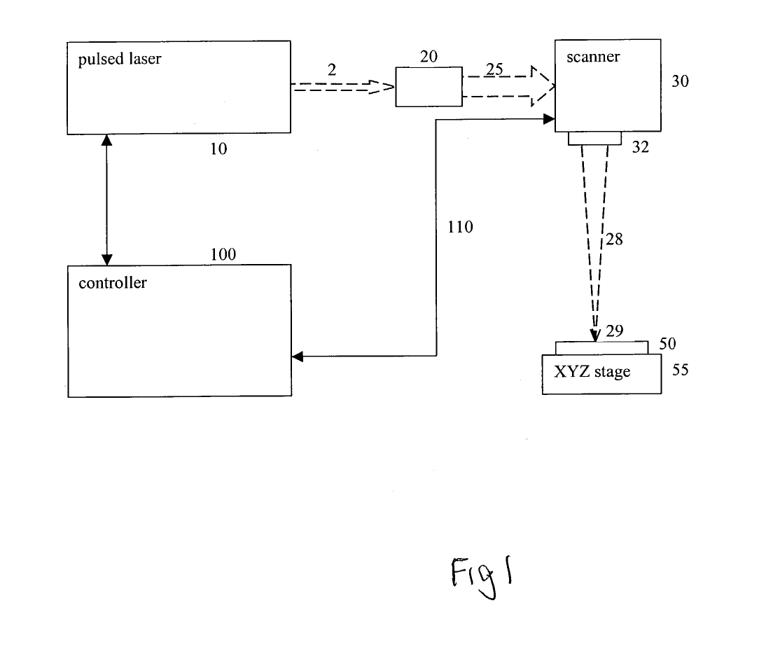

FIG. 1 illustrates one embodiment of a laser system of the present invention. that can utilized for laser surface modification according to the present invention. A pulsed laser system 1 comprises a laser 10, which preferably provides nanosecond pulses at UV wavelengths, emitting a beam 2 which is then expanded by optics 20 prior to entering a scan head 30. An f-theta objective 32 may comprise part of the scanner and is used to focus the laser beam onto target material 50, that is mounted on an XYZ stage 55. A controller 100 provides control and feed-back between a computer driving the laser and the scanner 30. The electronic feed-back loop allows for automation and hands-off operation as is commonly done in the art of laser material processing.

The laser is preferably a diode pumped solid state laser that operates with adjustable repetition rates, pulse energies and pulse durations, as discussed further below.

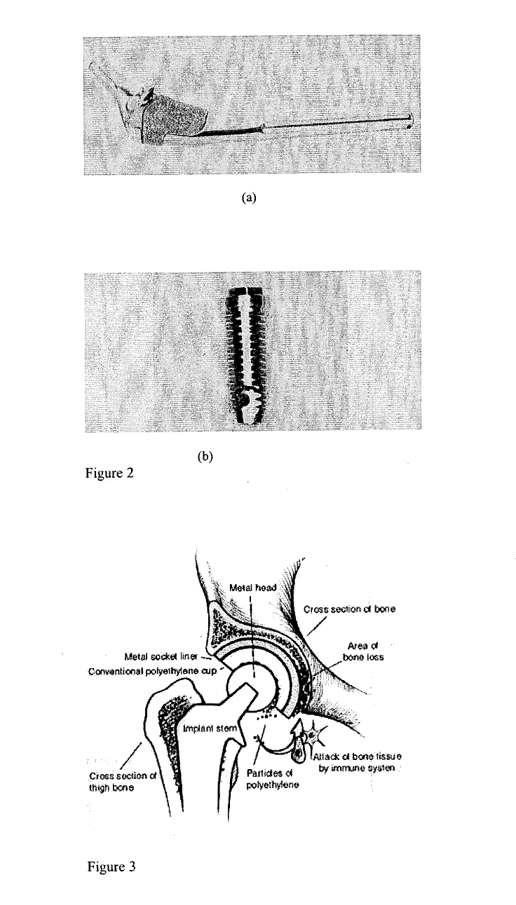

A particularly useful application of the system 1 is to biomedical implants, comprising a variety of different target materials including but not limited to Ti and Ti-6Al-4V, and the like, used in the orthopedic and dental industries for implant procedures such as with hip replacements, as shown in FIGS. 2a and 2b. This is because of their attractive combination of properties such as biomedical compatibility, corrosion resistance and mechanical properties. Schematic of components and interfaces involved in total hip replacement is shown in FIG. 3.

Laser surface modification techniques for implants as shown in FIGS. 2 and 3 using the system of FIG. 1 are proposed to optimize the engineering of improved bone/Ti-6Al-4V integration. In particular, techniques utilizing the UV radiation from a pulsed solid state laser are used to produce micro-grooved surfaces with groove depths on the order of a few to tens of microns. (between 2 and 16 μm for the hip replacement implant). Through a series of experiments designed to test the efficacy and limitations of the proposed techniques it was recognized that unlike blast textured Ti-6Al-4V surfaces that give rise to random cell orientations, laser-textured Ti-6Al-4V surfaces promote contact guidance. We believe that this will result ultimately in the reduction of scar tissue formation during wound healing, following the insertion of an implant.

The preferred embodiment for UV materials processing utilizes diode pumped solid state (DPSS) lasers for this application. Solid state lasers are preferred due to to their excellent beam quality (compared to other types of lasers), high efficiency, overall safety, ease of installation, and long term stability. Commercial DPSS 355 nm lasers can now provide up to 10 W of TEM₀₀ output [examples).

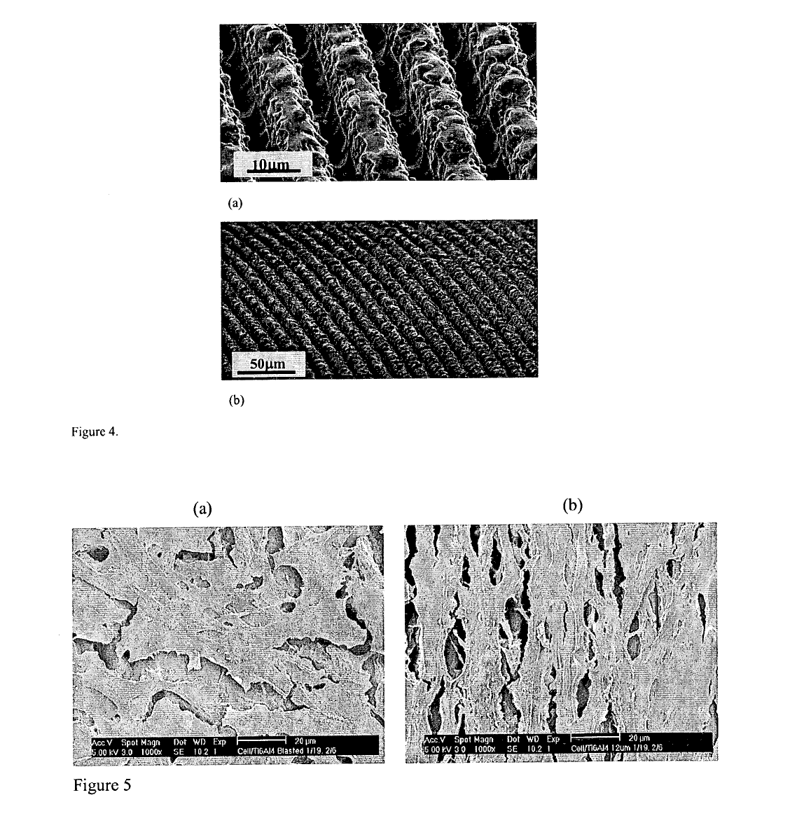

Solid state lasers have outputs that are typically relatively low in energy but high repetition rates allowing use of small area masking techniques avoiding the potential for the formation of cracks and heat affected zones within the micro-grooved structures, as was the case when excimer lasers were used before. FIG. 4 shows SEM photographs of excimer ablated grooves indicating extensive micro-cracks and heat affected zones.

Examples of Studies of Material Texturing

In an effort to address some of the above issues, Q-switched DPSS solid-state ultra-violet (UV) lasers were used to fabricate micro-groove geometries in a titanium alloy surface. The preference for the UV spectral range was indicated based on results of a prior study using lasers of different wavelengths (1064, 532, and 355 nm). UV lasers were used to introduce micro-groove geometries with depths between ˜6 and 150 μm in Ti and Ti-6Al-4V alloys [23]. The preliminary study also showed that micro-groove geometries with depths of ˜8-16 μm could be produced by the appropriate control of pulse frequency and the number of scans. Specifically our research examined dependence of groove dimensions and geometry on key laser processing parameters is examined. In an effort to identify optimal micro-groove geometries.

Key elements of the techniques that fall under the scope of the present invention have been described in a paper which presents the results of a recent study of the effects of nano-second UV laser processing parameters on the geometry and microstructure of a mill annealed Ti-6Al-4V alloy. In the study described, the laser processing parameters (pulse repetition rate, feed speed and wavelength) were varied in an effort to produce micro-grooves with depths of ˜12 μm. The ‘optimal’ micro-groove geometries are also shown to promote the contact guidance that can give rise to reduced scar tissue formation and improved osseo-integration.

In particular, it was observed that the performance of implants fabricated from DPSS laser-textured Ti-6Al-4V is improved when micro-grooved geometries are used toalign cells, i.e., promote contact guidance on biomedical surfaces. FIG. 5 shows the difference between alumina blasted surface and a laser micro-grooved surface. Note the random orientation of cells on the rough surface and the alignment/contact guidance of cells on the micro-grooved one.

Study 1: Cell Surface Interactions

In this experiment, human osteosarcoma (HOS) cells were used in a 2-day cell culture experiment on laser micro-grooved Ti6Al4V surfaces to investigate the cell-surface interactions between (HOS) cells and laser micro-grooved Ti6Al4V surfaces.

Cell Culture

HOS cells were maintained at 37° C. in humid 5%CO₂-95% air. The culture medium was 89% DMEM, 10% fetal bovine serum, and 1% penicillin/streptomycin. The cells were split 1:5 whenever confluence was reached. The cells were harvested using trypsin at 0.25% concentration; the cells were then centifuged down to a pellet at 3500 revolutions per minute and resuspended in 1 mL of medium.

Ti6Al4V Surfaces

Micro-grooves were produced on two Ti-6Al-4V samples surfaces at a laser output of 355 nm (UV), with approximate dimensions ¼″×¼″×½″, using an YHP40 laser at the Spectra Physics Laboratories. The samples were cut from a ¼″ thick bend bar specimen and mechanically polished utilizing colloidal silica for the final polishing step.

Parallel grooves were produced on the sample by varying the processing parameters of pulse repetition rate, feed speed, and wavelength. The 100 mm focal length utilized in the secondary investigation was also used in the preparation of the two samples used in the 2-day cell culture. The processing parameters used in the surface grooving of the samples were the same as those used in the processing of samples C1 and C2 of the secondary investigation. All processing was again completed with a single beam pass. Each sample was comprised of two types of surfaces: polished and micro-grooved.

Before seeding the sample surfaces, the surfaces were cleaned and passivated. Each surface was first sonicated in a solution of distilled water and detergent for 30 min and then rinsed in deionized water 3 times for at least 1 min each time. Then each surface was sonicated in acetone for 30 min and then rinsed in deionized water 5 times for at least 1 min each time. Each sample was then passivated in 30% nitric acid for 15 min and then rinsed in deionized water 5 times for at least 1 min each time. Then the samples were each sterilized in 100% ethanol for 30 min and dried in a sterile hood. [5]

Preparation for SEM Analysis

The surfaces were removed from the media after 2 days. They were rinsed in 0.1M sodium phosphate buffer and fixed overnight in 0.1M sodium phosphate buffer with 3% gluteraldehyde. The surfaces were then dehydrated via a stepwise (30 min each step) alcohol dehydration (30%, 50%, 70%, 80%, 90%, 95%, 100% ethanol). The cells were then critical point dried in CO₂. The surfaces were fixed to SEM stubs and sputter-coated with a gold-palladium alloy in order to create a conducting surface for subsequent scanning electron microscopy.

Results and Discussion

Characterization of Micro-Grooves

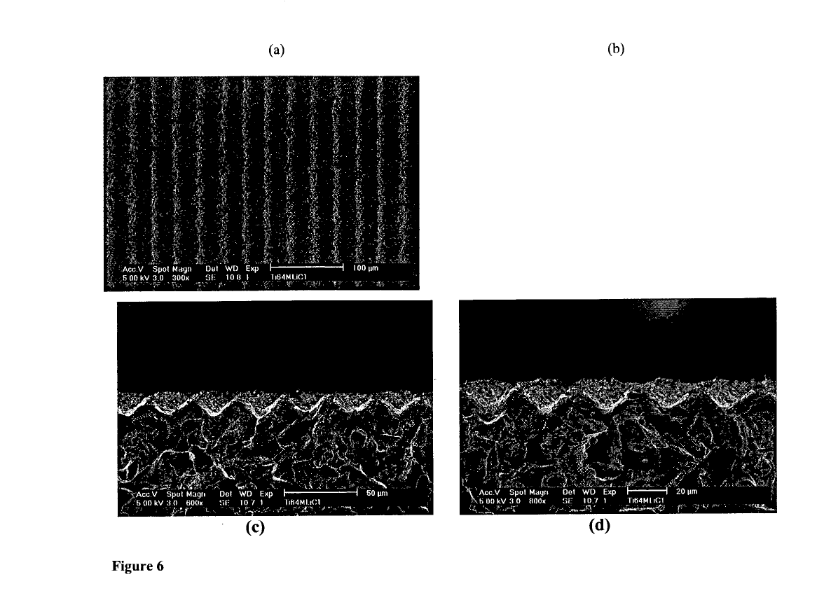

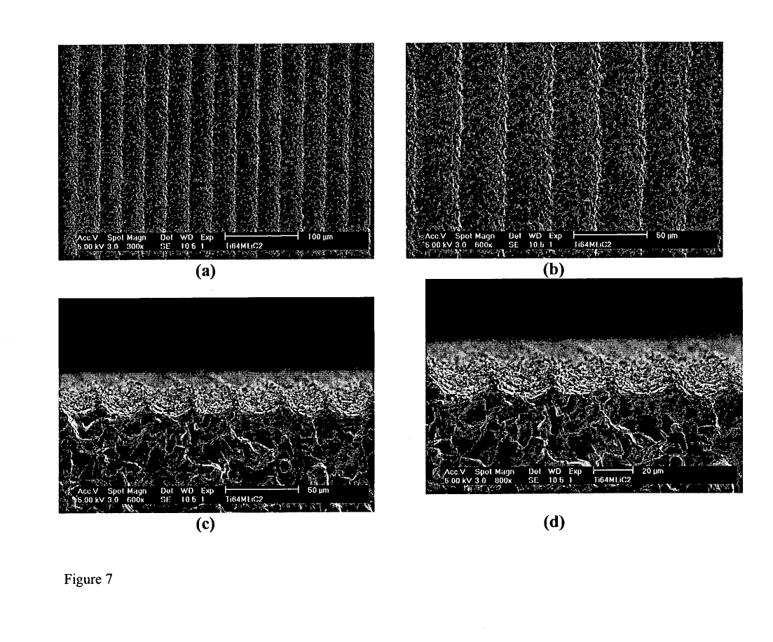

Micrographs of the samples were obtained using a Philips XL-30 Field Emission Scanning Electron Microscope (SEM). Both top-view and side-view micrographs were taken of the sample surfaces in order to measure groove dimensions, to examine the effects of the processing parameters on groove geometry and to study observable physical characteristics. FIGS. 6 and 7 represents the SEM images of the groove sections for samples C1 & C2. The sample labels C1 and C2 are representative of the fact that the samples were processed using the same parameters as those used for Sample C/Section 1 and Sample C/Section 2 respectively in the secondary investigation.

TABLE 1
Measured groove geometries Ti-6Al-4V.

| | Groove Width | Groove Depth |
|---|---|---|
| Sample # | (μm) | (μm) |
| C1 | 25 | 11 |
| C2 | 26 | 8 |

Observations of Physical Characteristics

As can be observed from FIGS. 6 and 7 and Table 1, the major difference between these samples and the samples produced in the secondary investigation with identical processing parameters lies in the groove width. One possible explanation for the discrepancy is the possibility of a slight difference in the height of corresponding samples. Another possibility is that the laser processing was affected by its optical limit and thus failed to reproduce the exact results reached in the secondary investigation.

Microstructure

In previous work, observation of the microstructure of surfaces micro-grooved by Excimer laser processing showed evidence of micro-cracks and heat-affected zones as a result of the processing. These phenomena are concerns because they represent deleteriously affected regions of the substrate that could negatively affect how cells respond to the substrate. No such phenomena were observed in the microstructure of the micro-grooved samples produced in laser processing by the Spectra Physics YHP40 laser (See FIG. 7), which suggests that the frequency-tripled diode pumped laser processing is a more efficient way of attaining the contact guidance achieved with the Excimer laser processing.

Cell-Surface Interactions

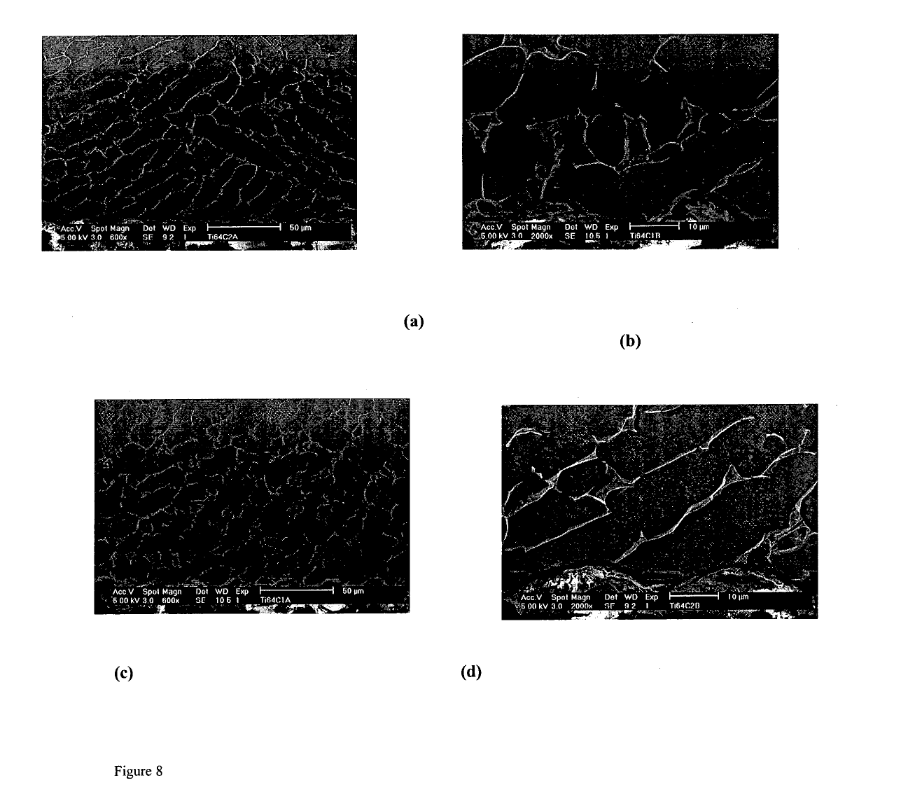

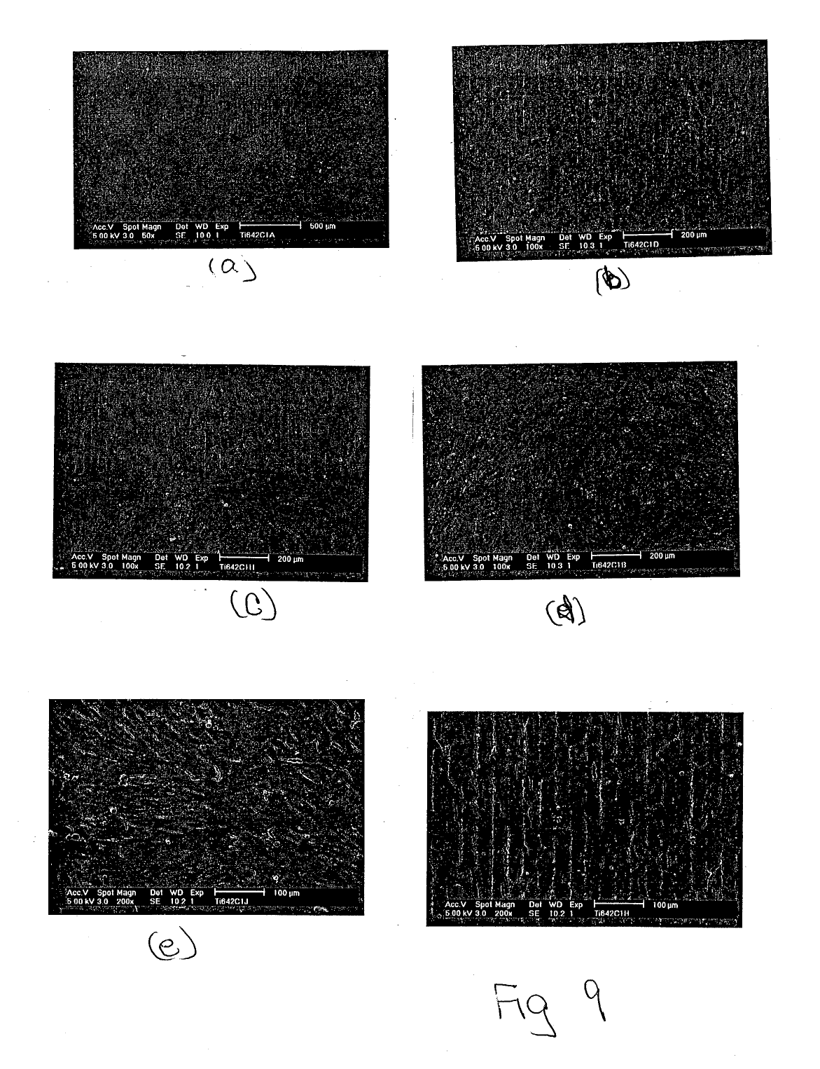

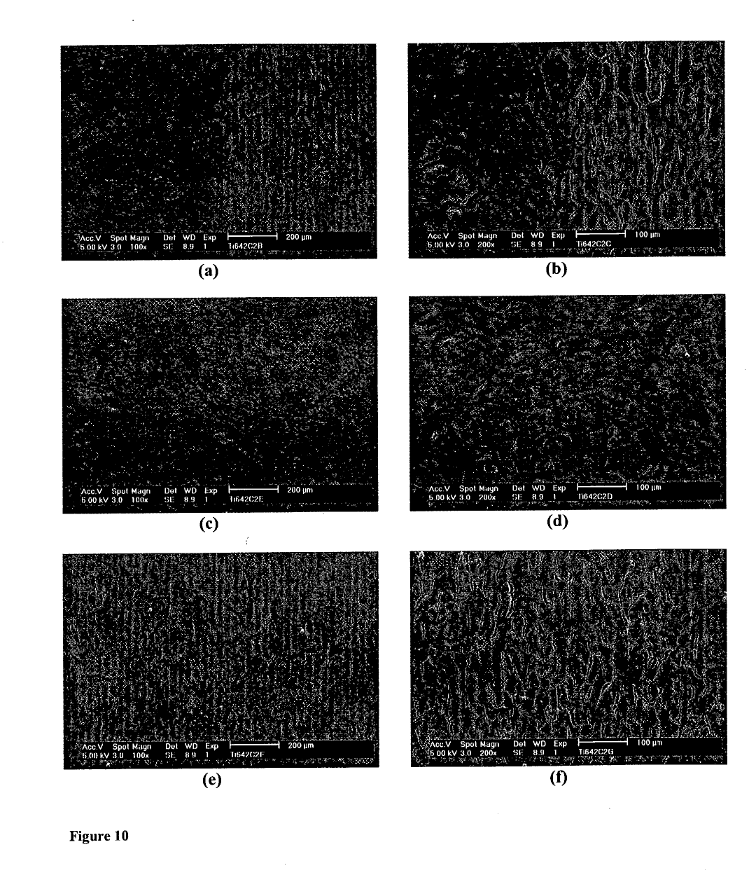

Scanning electron microscopy at 5 kV was used to observe the cell morphology on the micro-grooved Ti6Al4V surfaces [5]. On the surfaces of both C1 and C2, the intended contact guidance along the grooves was the morphological result of cells seeded on the micro-grooved portion of the sample. Contact guidance of a different sort was the morphological result of cells seeded on the polished portion of the sample: the cell orientation followed the direction of the submicron grooves created on the sample surface during the polishing process (See FIGS. 8 and 9).

Note: In the Preliminary Investigation into the Interactions between HOS Cells and Laser Micro-Grooved Ti6Al4V Surfaces, the procedural sections entitled “Cell surfaces” and “Preparation for SEM” are exactly as they are printed in source 3 as well as the first and third paragraphs of the section entitled “Ti6Al4V surfaces.”

Conclusions

Contact guidance of HOS cells on laser micro-grooved Ti6Al4V surfaces was achieved. This result and the lack of micro-structural defects such as heat affected zones and micro-cracks offers the Spectra Physics YHP40 laser processing as a more efficient way of achieving contact guidance. These results indicate that textured surfaces produced by frequency-tripled diode pumped lasers like the Spectra Physics YHP40 laser are effective in the intended manipulation of cell orientation and provide tissue engineers with a more efficient alternative in laser texturing to Excimer laser processing.

Note that although sarcoma cells were used in the study, more recent experimentation using osteoblasts (human bone generating cells) confirmed similarly good indications of contact guidance and alignment of the grooves to the cells. This is expected to considerably decrease scar tissue formation in biomedical implants.

Further investigation into contact guidance and levels of adhesion produced by different types of textured surfaces, e.g., patterns of grooves have also been conducted, revealing effective methods of minimizing scar tissue formation at the bone-implant interface while promoting cell integration and adhesion.

Study 2: Optimization of the Micro-Groove Laser Processing of Ti6Al4V Surfaces Using a Diode Pumped Solid State Laser (DPSSL).

A parametric study was conducted of UV laser processing parameters (pulse repetition rate, feed speed and wavelength) on micro-geometry, topology and microstructure. The laser processing parameters required for the formation of ˜12 μm grooves were presented in a paper incorporated by reference herein.

The results from the preliminary set of experiments indicated that the micro-grooves developed at a laser output of 355 nm (UV) produced grooves closest to the optimal groove geometrics. Hence, a second parametric study was performed in which a wavelength of 355 nm used, and the feed speed and pulse repetition rate were varied. The second set of experiments also employed a focal length of 100 mm, instead of the 160 mm focal length that was used in the preliminary experiments. The shorter focal length lens was used to achieve a smaller spot size, and consequently smaller groove dimensions. All the laser processing was completed with a single beam pass. The second set of laser processing parameters summarized in Table II.

TABLE II
Second set of processing parameters used for the surface
grooving of Ti-6Al-4V.

| Groove | Pulse | | | |
|---|---|---|---|---|
| Section | Repetition | Feed Speed | Average power | Spacing between |
| # | Rate (kHz) | (mm/s) | on sample (W) | grooves (μm) |
| 1 | 50 | 200 | 1.9 | 30 |
| 2 | 50 | 300 | 1.9 | 30 |
| 3 | 40 | 200 | 2.6 | 30 |
| 4 | 40 | 300 | 2.6 | 30 |
| 5 | 60 | 100 | 1.3 | 30 |
| 6 | 60 | 200 | 1.3 | 30 |

Micro-Groove Geometry

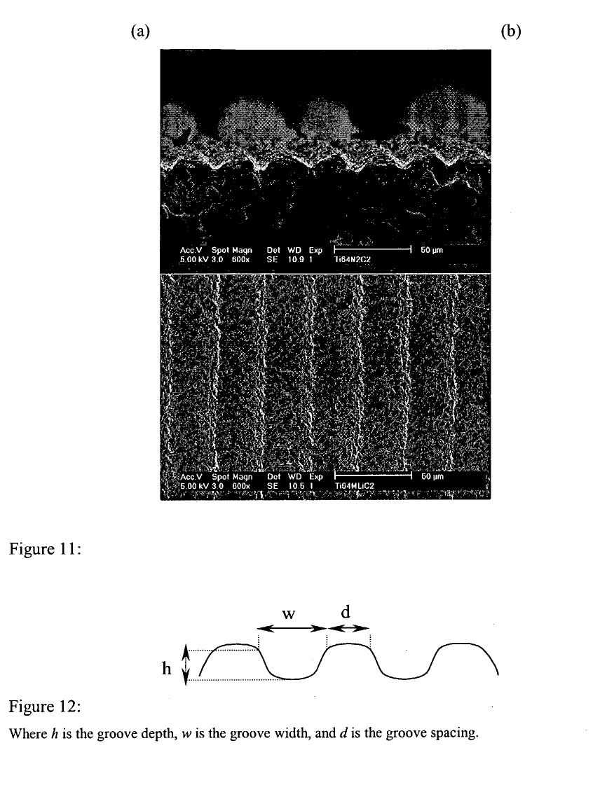

The geometries of the micro-grooved samples were examined using a Philips XL-30 Field Emission Scanning Electron Microscope (SEM). A typical top-view and cross-sectional view are presented in FIG. 11. These show a uniform micro-groove geometry and surface topography. A schematic idealization of the groove geometry is shown in FIG. 12, in which the groove dimensions are also illustrated. The measured groove dimensions are summarized in Table III.

TABLE III
Measured groove geometries of Ti-6Al-4V samples

| | Spacing between | Groove width | Groove Depth |
|---|---|---|---|
| Groove Section # | grooves (μm) | (μm) | (μm) |
| 1 | 16.9 | 14.1 | 11 |
| 2 | 14.1 | 14.1 | 10 |
| 3 | 14.1 | 18.4 | 10 |
| 4 | 14.1 | 18.4 | 9 |
| 5 | 15.0 | 16.9 | 18 |
| 6 | 16.9 | 16.9 | 5 |

Micro-Groove Surface Topology

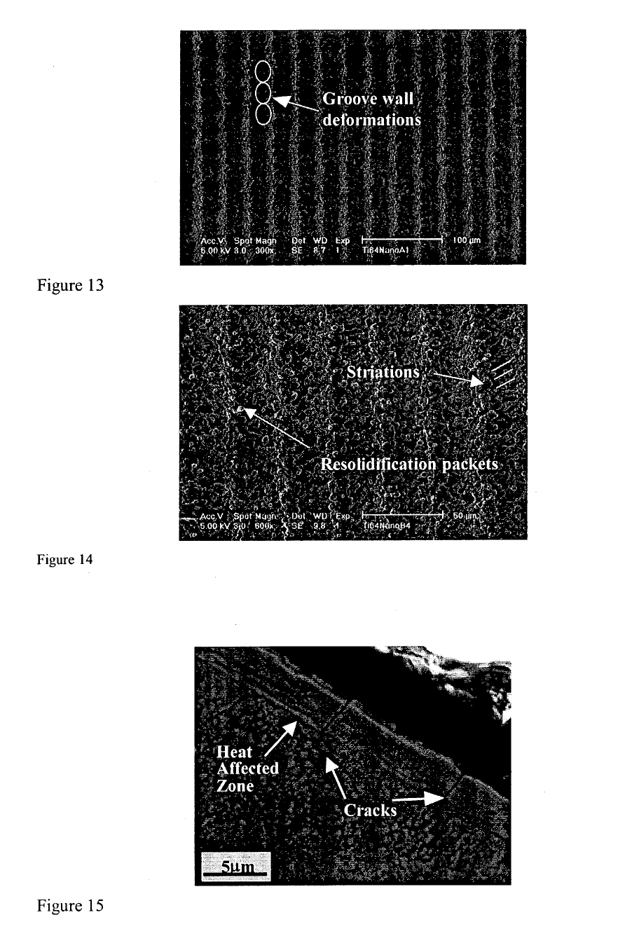

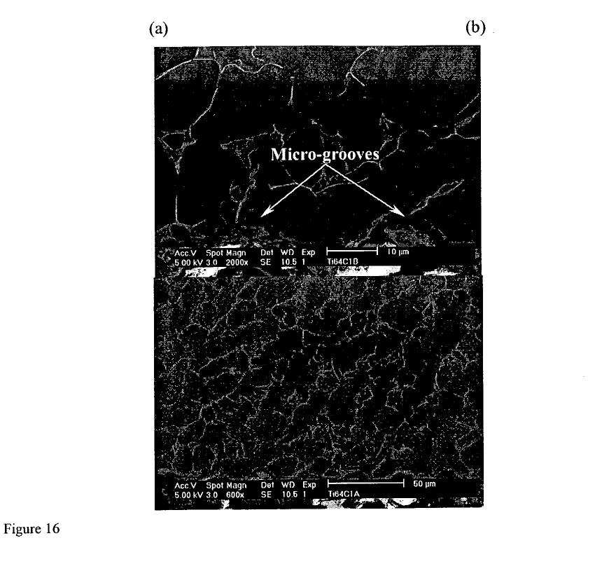

Three general types of surface features were observed on the laser processed samples. These included: resolidification packets, striations, and the deformation of groove walls in the form of repeated round sections along the lengths of the grooves (FIGS. 13 and 14).

The resolidification packets represent areas where the laser melted the surface of the titanium alloy, and the material resolidified. In the preliminary set of experiments, resolidification packet size and incidence were observed to increase with increasing wavelength. It was postulated that this phenomenon was due to the increased power input on the sample associated with increased laser wavelength. The results from the secondary set of experiments suggest that resolidification packet size and incidence increase slightly with the combination of increasing average power (a function of wavelength) and decreasing pulse repetition rate.

In FIG. 14 the striations appear as oblique lines running along the length of the grooves. These develop within the grooves during laser processing. A comparison of the distance traveled (along the sample) between laser pulses and the mean spacing between striations, in the preliminary set of experiments, suggests these physical marks are due to the pulse repetition rate of the laser. Since the sample travels a certain distance between pulses, the striations are created each time the laser removes material from each pulse.

In the preliminary parametric study, the striations were only evident in the grooves produced with a 355 nm wavelength. This might be because smaller wavelengths introduce less power into the sample and hence leave less time for the material to equilibrate and resolidify. The lack of evidence of striations in the second investigation suggests that the appearance of this physical phenomenon may be the result of multiple factors: depth, level of resolidification, and size of resolidification packets in the actual grooves. The depth factor was considered because the grooves containing striations in the preliminary set of experiments were below seven microns in depth. The resolidification factor was suggested because resolidification in the grooves conforms to the pattern of the striations.

In the preliminary experimental tests, it was suggested that the deformation of the groove walls might be due to the motion of the mechanized stage and a function of the laser spot size. If the motion of the sample is not continuous, but rather staggered, then the round or wave like appearance of the walls may be due to the momentary pause of the laser and represent the spot size of the laser. The second parametric study supports this conjecture, as a smaller spot size was used in the laser process. Observations from this second study showed that the repeated round sections were much smaller than the ones in the preliminary parametric study.

Microstructure of Laser Micro-Grooved Surfaces

In prior work, the microstructure of micro-grooved Ti-6Al-4V surfaces produced by Excimer laser processing showed evidence of micro-cracks and heat-affected zones. These phenomena represent areas of concern because they can degrade the fatigue performance of biomedical implants with Excimer laser micro-grooves. In contrast, no evidence of heat-affected zones or cracking was observed in the microstructure of the micro-grooved samples produced by UV laser processing with the Spectra Physics YHP40 laser (FIG. 15). The duplex microstructure present prior to processing (was similar to that of the post-processed samples (FIG. 15). This suggests that frequency-tripled diode pumped UV laser processing is a better alternative to Excimer laser processing.

Ultraviolet (355 nm) laser processing and the appropriate selection of parameters such as feed speed, pulse repetition rate, and average power on sample lead to the groove dimensions deemed optimal for contact guidance of cells (8-12 μm width and depth) These micro-groove geometries are close to optimal groove geometries that promote contact guidance and cell integration as determined in an early study [20].

YHP40 laser processing produces three observable physical characteristics: resolidification packets, groove wall deformations, and striations. These characteristics are a function of the laser parameters mentioned above, the laser spot size, and the mechanical motion of the processing stage. Their appearance warrants further investigation into their production and affects on cell adhesion and cell spreading.

Relatively straight and uniform micro-grooves were also produced in Ti-6Al-4V using solid-state lasers operated at various wavelengths (355 nm—UV, 535 nm—green, and 1064 nm—IR), pulse frequencies (40 kHz, 50 kHz, and 60 kHz), and feed speeds (100 mm/s, 200 mm/s, and 300 mm/s). Unlike the Excimer lasers, no evidence of heat affected zones or solidification cracks were observed in the micro-grooves produced using. the solid-state lasers.

The micro-grooves developed with a pulse frequency of 50 kHz, a focal length of 100 mm, feed speeds ranging from 200-300 mm/s, and a wavelength of 355 nm produced micro-groove geometries near the targeted groove width and depth of ˜12 μm. These micro-grooves had respective depths and widths of ˜11 μm and ˜14 μm. Further adjustments to the groove geometry may be achieved by control of lens focal length that controls the spot size.

The results from this study suggest that nano-second solid-state UV lasers can be used to introduce the desired micro-groove geometries. The desired 8-12 μm groove depths and widths can be achieved by control of wavelength, pulse frequency, and feed speed. However, the appearance of the three types of surface features (resolidification packets, striations and wall deformations) suggests further investigation in the following areas:

a. Pulse repetition rate, feed speed and striation spacing.

b. Mechanical stage motion, laser spot size and wall deformations.

Further experimentation with laser micro-groove patterns on Ti6Al4V and close observation and analysis of cell-surface interactions such as cell adhesion and cell spreading should shed light on the type and range of surfaces suitable for hip and dental implants. Investigations along these lines are ongoing.

We claim:

1. A method of modifying a surface of an article, comprising:
providing a pulsed solid state laser that produces a UV output;
directing the UV output to the surface; and
producing micro-grooved surfaces with groove depths in the range of 1 100 μm.
